(19) United States
(12) Patent Application Publication
(10) Pub. No.: US 2026/0120042 A1
(43) Pub. Date: Apr. 30, 2026

(54) SYSTEMS AND METHODS FOR PROSPECT-AGENT PAIRING TO IMPROVE OUTCOMES OF PROSPECT-AGENT INTERACTIONS

(71) Applicant: Quantimedia, LLC, Glendale, CA (US)

(72) Inventor: Hovannes Zakian, Glendale, CA (US)

(21) Appl. No.: 19/376,833

(22) Filed: Oct. 31, 2025

Related U.S. Application Data
(60) Provisional application No. 63/714,764, filed on Oct. 31, 2024.

(51) Int. Cl. G06Q 10/067

(52) U.S. Cl. CPC G06Q 10/067

(57) ABSTRACT

There is disclosed systems and methods for creating a prospect-agent pairing model comprising retrieving historical transaction data to be used in training a model for prospect-agent pairing, analyzing historical transaction data, creating a plurality of prospect-agent pairing models based on the historical transaction data, evaluating the plurality of prospect-agent pairing models, and selecting a preferred model based on a desired outcome. There is further disclosed methods and systems for implementing prospect-agent pairing, the model comprising, receiving a new inquiry requesting a prospect-agent pairing for a new transaction from a user, generating a prospect-agent pairing using the selected pairing model, wherein the prospect-agent pairing is based on a trained model optimized for pairing a prospect and an agent using the agent as an attribute in determining the ideal prospect-agent pairing, and providing the prospect-agent pairing results to the user.

### BACKGROUND

The invention relates to identifying and selecting prospect-agent parings with the highest probability of success.

### SUMMARY

The present disclosure is directed to systems and methods for prospect-agent parings with the highest probability of success, substantially as shown in and/or described in connection with at least one of the figures, as set forth more completely in the claims.

### BRIEF DESCRIPTION OF THE DRAWINGS

FIG. 1 shows a diagram of an exemplary system for improved prospect-agent pairing, according to one implementation of the present disclosure;

FIG. 2 shows a flowchart illustrating a method of training a system for improved prospect-agent pairing, according to one implementation of the present disclosure; and

FIG. 3 shows a flowchart illustrating a method of improved prospect-agent pairing, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

Disclosed are new and useful systems for increasing productivity of prospect-agent pairings for a provider of goods or services, wherein the system may execute a new and useful method for achieving the desired outcome by determining a best match between a prospect, a task, and an agent. The system uses data about new prospects who are interested in engaging with or purchasing a business' products or services. The system also uses data about existing prospects who are currently engaged with the provider's products or services, such as existing clients or customers.

A prospect may be an entity requesting an action or task to be performed. A prospect may be an existing user of a provider's goods or services or a prospective user of a provider's goods or services. A prospect may be an entity or individual interested in receiving goods or services from the provider, regardless of the prospect's prior interaction with the provider. Systems and methods described may utilize prospects and prospect data for optimization purposes, not only for historical data purposes.

The method for prospect-agent pairing may identify an agent to act on behalf of a business in a sale or service transaction. An agent may be a salesperson, a service provider, an employee, a contractor, or other representative of the business. The agent may provide a service on behalf of the business or sell products on behalf of the business.

Prospect interest may also generate a requested task and associated data. The system uses the prospect data and generated task data to identify various characteristics of the prospect and generated task, which may be information directly collected from the prospect and information collected from the transaction with the prospect. The identified characteristics may include but are not limited to characteristics such as a type of service or product requested, a service or product category, a prospect gender, a prospect address, an urgency of the request, a prospect marital status, if a prospect was acquired through a promotional or advertising campaign, and which advertising or promotional campaign the prospect was acquired through.

The characteristics may be optionally enriched. Data may be enriched when the prospect-provided data is supplemented by public or non-public data, such as census data. Additional characteristics may be demographic data including income data, such as median household income, education level, population density, and home value information, such as a median home value in a neighborhood where the prospect lives or the requested services are to be rendered. Demographic data may include information related to the area where the services are to be rendered, where the agent is located, or where the prospect is located. The characteristics, whether gathered directly or enriched, are used as attributes in the determination of the best agent for a particular scenario or task.

In some implementations, the system may save historical-instance data associated with multiple agents. The historical-instance data may include information about a particular agent and about transactions involving that agent, including the prospect and task information from a transaction and the outcome of that transaction. The outcome of the transaction may include whether a sale was closed, a customer was retained, an issue was resolved, or other identified positive outcome of the transaction was reached, and any additional information gathered about the prospect and the transaction (such as direct survey feedback from the prospect). Agent data may be used as an attribute in the determination of the best agent for a particular scenario.

Based on the historical-instance data and accompanying prospect data and agent data, the system creates one or more predictive models to predict the outcome of a particular scenario. The system may also intermittently or continually incorporate prospect data and agent data from new scenarios into the predictive model as new scenarios or tasks are completed by agents. In some cases, the scenario may be the outcome of a sales transaction. The system may create a plurality of models in which each model may be optimized for different scenarios, outcomes, or agents. Generation of the one-or-more models may incorporate attributes related to the prospect and include the agent as an attribute. The system then tests the generated models to identify a preferred model. Factors the system may use to identify the preferred model may include the target class to be optimized. For example, the system may test for prediction accuracy, fit/overfit to data, false positive rates, false negative rates, etc. The efficacy of the system may be improved by the use of data pre-processing and information gain analysis, as well as larger sets of prospect data and larger sets of agent data.

Data pre-processing reviews prospect and agent data to identify attributes that may hinder modeling efforts via software code, which may identify problematic attributes in instance data such as null attribute values, attribute values that are out of scale when compared with other attributes values, and attribute values that are of an undesirable type such as numerical values when nominal values are desired. The system may also apply standard data science practices, such as replacement of null values with zero value, replacement of null values with the most commonly found value for the attribute type, or by removing attributes with null values. For instances with attribute values that are out of range, normalization techniques may be used to scale them appropriately. For instances with attribute values that are of an undesirable type, such as numerical values where nominal values are desired, the attribute may be split into bins and numerical values replaced with categorical values associated with those bins. There are many data pre-processing techniques known to those skilled in the art of data science. The examples above are only examples and should not be interpreted as limiting.

The system may also perform class balancing if the data set shows sufficient skew in the target class and it is determined that class balancing would enhance model training efforts. The system may also perform an information gain analysis, or other dimensionality reduction technique known to those skilled in the art of data science, to rank the attributes associated with the instances according to the predictive value they provide to the modeling process. A threshold may be set in the information gain analysis to determine what attributes will be used for the modeling process. This information gain analysis may be performed multiple times to optimize the attribute set for various types of models. This information gain analysis may also be performed multiple times as new historical-instance data is made available to account for changes in the data set. Scarce data sets often require dimension reduction. As data sets become less scarce, more dimensions can be used for model training and prediction.

Larger sets of prospect data may be improved by including a larger number of prospects and historical task outcomes. Larger sets of agent data may be improved by an agent having more interactions reported. This may allow the system to generate a more effective mapping of agents to prospect and task attributes that will result in the desired outcome of the particular scenario for which the pairing is optimized. In some situations, the selection of the model to be implemented may be manual. In other situations, the selection of the model to be implemented may be automated.

In creating the preferred model, the system utilizes the optionally processed and enriched historical-instance data, splitting the data set into a training data set and a testing data set. This split may be an 80:20 split with 80% of the data set used for model training and 20% used for testing the trained models. The split may also be a cross validation split with 5 or 10 folds. The ratio of splits or the number of folds for cross validation are merely examples. However, an 80:20 split or a 10-fold cross validation is well known to those skilled in the art of data science. The system retrieves attributes from the historical-instance data that are suitable for training the predictive model for the target scenario. The system then trains one or more models capable of predicting the target scenario.

Models may be selected from a multitude of model types, such as regressions, decision trees, support vector machines, neural networks, and other predictive models known to those skilled in the art of data science. Models may be trained with the agent treated as an attribute in the model, or multiple models may be trained for a particular agent. As an example, there may be one model that uses task attributes and the agent that was assigned to the task, also treated as an attribute, to forecast the target scenario based on the combination of task attributes and agent. Alternatively, there may be one model for each agent that uses task attributes to forecast the target scenario based on the task attributes. For certain model types, this second approach may better allow for different weights for attributes based on the agent.

The system then evaluates each generated model for predictive suitability. The system may calculate one or more evaluation metrics, such as accuracy, precision, recall, F-Score, Area Under the Curve (AUC), or others known to those skilled in the art of data science. The system may then rank the generated models based on one or more of these evaluation metrics. The system may also determine inability to predict the target scenario based on evaluation metrics, such as low AUC. The system may then use the rankings to determine the ideal predictive model.

Once the system identifies the ideal model to apply in the particular target scenario, the system receives data associated with a prospect where the target scenario is not complete. The prospect data will include information entered by or about the prospect and may include enriched data gathered from external data sets, external data sources, or inferred from external data. The prospect data may also be pre-processed. The prospect data may additionally include data gathered during the completion of the target scenario. The system uses the prospect data as attributes in the predictive pairing model. The system considers agent data as an attribute in the determination of the most productive pairing and may alter a pairing during the scenario completion process if new data becomes available that changes the predicted optimal agent assignment.

The system passes the optionally enriched and pre-processed prospect data to the optimal predictive model and records the output of the predictive model. The output may include the predicted outcome of the target scenario as well as the probability of the predicted outcome. Where one predictive model is deployed that incorporates each agent as an attribute, the system passes prospect data along with a discrete agent value to the predictive model and iterates through all available agents. As an example, the system would pass to the predictive model new prospect data having attributes 1 through n plus the attribute of Agent A and record the output. The system would then pass the same information to the model, except varying the agent attribute to Agent B. The system would then keep iterating until a predicted outcome of the target scenario for all agents has been generated for the given new prospect data. Where one predictive model is deployed per agent, the system passes the prospect data to each agent-specific model and records the output for each along with the agent for which that model was trained. In either instance, the system records the outputs of the predictive model, then evaluates the recorded outputs and ranks the agents based on the highest predicted likelihood of a successful resolution of the target scenario.

The system returns a recommendation based on the result of the predictive model, providing a best prospect-agent match or providing a list of multiple agents who may pair well with the particular prospect. In some implementations, the system may provide a ranked list of agents, allowing for selection of a best-fit agent, while also taking into consideration other external factors such as location, scheduling, availability, etc. In some implementations, the recommendation process may integrate with a calendar management system or other workforce management platform to allow for consideration of factors such as agent availability prior to making recommendations. The results of the pairing may be communicated to a user by an API, a graphic interface, a messaging system, or other means of displaying or communicating data.

After the interaction between the agent and the prospect is completed, the system may be updated with the outcome of the transaction. The whole process may be implemented as training data for improving the system and method in future implementations. Accordingly, the method may allow the system to learn and improve based on the results of each performed pairing. An ongoing feed of outcome information will allow the system to continuously improve the predictive model with additional data and to retrain the predictive models to better reflect changes in prospect and agent behavior and performance. The collection and feeding of outcome information may be run periodically or continuously.

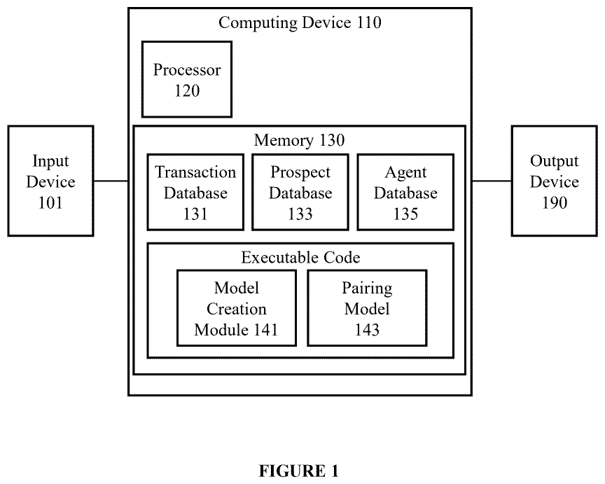

FIG. 1 shows a diagram of an exemplary system for improved prospect-agent pairing, according to one implementation of the present disclosure. System 100 includes input device 101, computing device 110, and output device 190. Input device 101 may be a user device, such as a personal computer, a mobile phone, a tablet computer, or other device used by a user to access the internet for searching. Input device 101 may be a computer terminal, such as a desktop computer, or a user device such as a mobile phone, a tablet computer, or other personal computing device. Input device 101 may include an input interface, such as a physical keyboard or a touchscreen, a microphone for voice input, or other user input interface capable of receiving user input. In some implementations, input device 101 may include a display. In some implementations, input device 101 may be connected to computing device 110 via a computer network such as a local area network, a wide area network, a wireless network, or the internet.

Computing device 110 includes processor 120 and memory 130. Processor 120 is a hardware processor, such as a central processing unit (CPU) used in computing devices. Memory 130 is a non-transitory storage device for storing computer code for execution by processor 120 and also storing various data and parameters. As shown in FIG. 1, memory 130 includes transaction database 131, prospect database 133, agent database 135, and executable code 140.

Transaction Database 131 is a computer database for storing transaction information. Transactions may include instances of communication between a business and a prospect. The interaction may be a result of the prospect showing interest in a product or service provided by the business, or the interaction may be the result of the business contacting the prospect to offer a product or service, either because the prospect showed interest in the product or service or because the business wanted to inform the prospect about the product or service and offer it to the prospect. Transaction data stored in transaction database 131 and may include historical data about past transactions, including a type of transaction, the service or product offered in the transaction, a prospect-agent pairing model used in the transaction, optional enrichment data, the outcome of the transaction, the satisfaction of the prospect, and an agent involved. In some implementations, a new entry in transaction database is created for each transaction of the business. The new entry in transaction database 131 may be updated with additional information, such as the identity of an agent assigned to the transaction and an outcome of the transaction, as the transaction progresses. In some implementations, transaction database 131 may store transaction data about transactions corresponding to a plurality of businesses. In some implementations, the plurality of businesses may offer the same products and services or different products and services. Compilation of data across businesses may improve transaction outcomes by providing a larger dataset for determining ideal prospect-agent pairings in subsequent transactions.

Prospect database 133 is a computer database for storing prospect data. Prospect data may include information about a prospect, such as the prospect's name, address, phone number, and other contact information. Prospect data may include a product or service sought by the prospect, whether the prospect has completed any past transactions, an outcome of the past transaction or transactions, and other prospect provided by the prospect. In some implementations, prospect data may include information gathered by the business, such as demographic data based on enrichment data related to the prospect data.

Agent database 135 is a computer database for storing agent data. Agent data may include agent profiles, including demographic data, transaction history, and outcome data for each transaction. Agent data may include products and services sold by the agent and businesses the agent has worked for.

Executable code 140 comprises one or more software modules for execution to perform the method for improved prospect-agent pairing, according to one implementation of the present disclosure. As shown in FIG. 1, executable code 140 includes model creation module 141,

Model creation module 141 is a software module stored in memory 130 for execution by processor 120 to create prospect-agent pairing models according to an implementation of the present disclosure. In some implementations, model creation module 141 may create one or more prospect-agent pairing models based on historical transaction data, prospect data, and agent data. In some implementations, model creation module 141 may be a computer learning algorithm that analyzes a plurality of attributes in a dataset to create one or more models for determining a prospect-agent pairing. Model creation module 141 may use computer learning to create a model for selecting prospect-agent pairings that are likely to result in a successful transaction, such as a closed sale. During the training process and model creation process, model creation module 141 may include transaction history data, prospect data, and agent data. Model creation module 141 may include the agent data as an attribute.

Pairing model 143 is a software module stored in memory 130 for execution by processor 120 to create prospect-agent pairing, according to an implementation of the present disclosure. Pairing model 143 is a prospect-agent pairing model created by model creation module 141. In some embodiments, pairing module 143 may include one or more models for creation of prospect-agent pairings. Once a prospect-agent pairing model is created, it may be executed to output a prospect-agent pairing. The prospect-agent pairing may include more than one pairing. In some implementations, when a plurality of prospect-agent pairings are generated, the prospect-agent pairings may be presented to the client. The plurality of prospect-agent pairings may be presented to the client in an ordered list. The order of the list presented to the client may be based on the quality of the prospect-agent pairing, a confidence that the prospect-agent pairing will result in the desired outcome, or another preferred ordering scheme.

Output device 190—computer. The output device may be a computer, such as a personal computer, for displaying the prospect-agent pairing identified. In some implementations, output device 190 may be the same device as input device 101. In some implementations, input device 101, computing device 110, and output device 190 may be the same device.

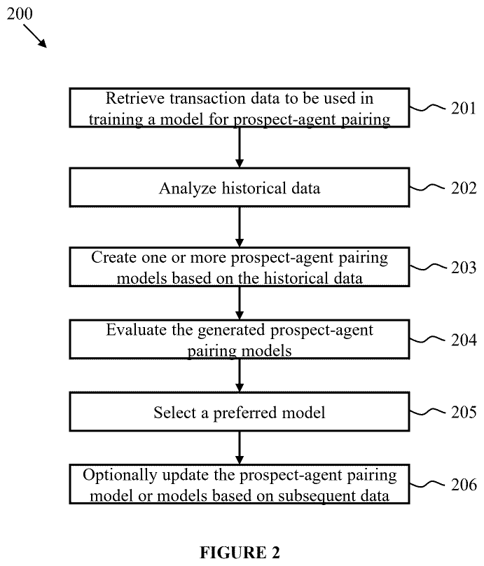

FIG. 2 shows a flowchart illustrating another aspect of the method of improved prospect-agent pairing, according to one implementation of the present disclosure. Method 200 begins at 201, where model creation module 141, using hardware processor 120, retrieves transaction data to be used in training a model for prospect-agent pairing. In some implementations, transaction data may include historical transaction data, prospect data, and agent data. Historical transaction data may be selected by a user based on demographic data, transaction type data, outcome data, etc. In some implementations, retrieval of transactions data may be in response to a user input requesting creation of a model. In other implementations, the user request to create a model may include the user providing a dataset, including transaction data, that the user wants to be used in the creation of the prospect-agent pairing model. Model creation module 141 creates one or more prospect-agent pairing models based on the training data.

In some implementations, transaction data may include historical data about tasks associated with a given provider. The tasks may be sales transactions, interactions of provider agents with prospects, or other tasks, such as providing a service of some kind. Transaction data may include agent data, prospect data, and outcome data. Transaction data may include information provided by the prospect, such as the prospect's contact information, personal information, financial information, business information, or the prospect's desired type of interaction with the provider. Transaction data may also be optionally enriched with additional attributes not provided by the prospect but derived by other means. Transaction data may include which agent was assigned to the task. The outcome data may include whether the agent succeeded at the task and the business outcome, as well as the degree of success.

At 202, model creation module 141, using hardware processor 120, analyzes historical data, including the transaction attributes (demographic and type of project, outcome data, etc.) and including the agent data as an attribute. Data analyzed may include transaction data, prospect data, and agent data. Each data set may be collected or enriched. The analysis may allow model creation module 141 to identify connections between variables in the transaction data, prospect data, and agent data that increase the probability of a desired outcome. In some implementations, the identified connection may include a single variable. In other implementations, the identified connection may include a plurality of variables. Model creation moule 141 may be able to identify combinatorial factors that a human either would not have thought to identify or would not have been able to identify.

Model creation module 141 may consider huge sets of data including a plurality of factors or attributes for each transaction, including age of the prospect, gender of the prospect, household income of the prospect, education level of the prospect, age of the agent, gender of the agent, education level of the agent, marketing channels used by the business, demographics of the prospect, demographics of the prospect's location,

Model creation module 141 may be capable of considering complex combinations of attributes or factors together. Model creation module 141 may calculate a probability of the desired outcome based on a combination of attributes or factors. By combining various sets of attributes or factors, Model creation module 141 may determine a ranking of attributes or factors which to combine to create a successful pairing model. By way of non-limiting example, model creation module 141 may consider a set of data including past prospect-agent pairings and the data associated with the pairings, including the outcomes. Model creation module 141 may determine that a particular agent, Agent 1, had better outcomes with prospects who met certain complex sets of criteria, such as prospects who requested an HVAC tune up, are in the 30% th percentile of income, have college degrees, and found the business on through an advertisement posted on a particular social media platform.

At 203, model creation module 141, using hardware processor 120, creates one or more prospect-agent pairing models based on the historical data. The step includes utilizing the analysis and gathered data to create one or more predictive models that predict the desired outcome of tasks based on attributes of the gathered data. For purposes of creating the predictive models, the method includes using the assigned agent as an attribute. An attribute is a characteristic or feature that is measured for each transaction and can change from one transaction to another in the dataset.

Different from known methods, model creation module 141 does not rely on explicitly measuring identified parameters and using the identified parameters to determine a prospect-agent pairing. In some implementations, model creation module 141 may wholistically consider data. Using machine learning, model creation module 141 may improve

At 204, model creation module 141, using hardware processor 120, evaluates one or more of the generated prospect-agent pairing models. In some implementations, the evaluation is to rank the created models for optimized prospect-agent pairing. Each model may be optimized for one or more different parameters, or each may be a different model optimized for the same parameters. Analysis of the created models may include evaluating the predictive models for desired features, such as prediction accuracy, fit or overfit to data, false positive or false negative rate, or other selected for criteria, in order to identify the models that best fit the desired features.

At 205, model creation module 141, using hardware processor 120, selects a preferred model. Model selection may be automated or may be manual. The selected prospect-agent pairing model may be used to select one or more prospect-agent pairings for a business for future transactions.

At 206, model creation module 141, using hardware processor 120, optionally updates the prospect-agent pairing model or models based on subsequent data, such as additional historical data, including the business outcomes of prospect-agent pairings selected by the model.

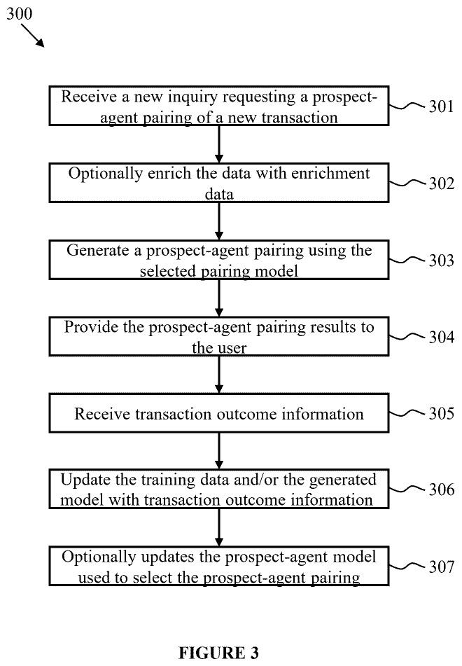

FIG. 3 shows a flowchart illustrating a method of improved prospect-agent pairing, according to one implementation of the present disclosure. Method 300 begins at 301, where pairing model 143, using hardware processor 120, receives a new inquiry requesting a prospect-agent pairing of a new transaction. In some implementations, the request may be include new prospect data. The request may be for a single prospect-agent pairing for project-by-project recommendations, or the request may include a prospect list (such as a lead list) for pairing large sets of prospects with optimized agents. At 302, pairing model 143, using hardware processor 120, may optionally enrich the data with enrichment data. Enriching the data may include gathering new data about tasks that have not been completed yet. Data gathered about uncompleted tasks may include agent data and prospect data.

At 303, pairing model 143, using hardware processor 120, generates a prospect-agent pairing using the selected pairing model. The prospect-agent pairing may be optimized based on a desired outcome. To generate the prospect-agent pairings, pairing model 143 may use the gathered and optionally enriched new data to pair the prospect with an agent, wherein pairing model 143 may treat the assigned agent attribute as an independent dimension that can be altered, thereby generating at least one predicted outcome of the uncompleted task given a certain combination of prospect data and agent. The predicted outcome may include the predicted result of a prospect and agent combination, the likelihood of the predicted result, the business outcome of the predicted result, the degree of success of the assigned agent in achieving the predicted result, and the agent used to generate the predicted result.

In some implementations, pairing model 143 may include a plurality of models generated by model creation module 141. Pairing model 143 may use at least one generated model to create a list including at least one agent and the agent's likelihood of achieving the desired result. Pairing model 143 may generate multiple results, pairing a plurality of agents with each prospect. In some embodiments, the multiple results may be ranked results. The results may include alternative results, providing an option if the first or selected agent is not available for the particular task. The rankings in the list may be optionally affected by other agent factors, such as agent availability, task saturation, calendar schedule, agent geographic location compared to the prospect, and commission rate.

At 304, pairing model 143, using hardware processor 120, provides the prospect-agent pairing results to the user. The results may be provided via API, graphical user interface, email notification, etc. In some implementations, providing results may include displaying the results of the prospect-agent pairing on a screen of output device 190. In other implementations, providing results may include transmitting the results of the prospect-agent for display or communication on another device. The suggested prospect-agent pairing may optionally actually assign the agent to the prospect. A suggested prospect-agent pairing may also optionally vary over the course of task completion as new prospect and agent data is gathered.

At 305, system 100, using hardware processor 120, receives transaction outcome information. In some implementations, system 100 receives transaction outcome information from the user. In other implementations, system 100 receives transaction outcome information by automated response. At 306 system 100 may update the training data and/or the generated model with transaction outcome information. In some implementations, model creation module 141 and/or pairing model 143 may utilize the collected transaction outcome information and associated prospect and agent pairing data as part of the data gathered during the historical data gathering first step of method 200, the next time method 300 is utilized. At 307, pairing model 143, using hardware processor 120, optionally updates the prospect-agent model used to select the prospect-agent pairing from which the results were generated.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method for creating a prospect-agent pairing model suing a system comprising a non-transitory memory storing an executable code and a hardware processor executing the executable, the method comprising:
retrieving, using the hardware processor, historical transaction data to be used in training a model for prospect-agent pairing;
analyzing, using the hardware processor, historical transaction data;
creating, using the hardware processor, a plurality of prospect-agent pairing models based on the historical transaction data;
evaluating, using the hardware processor, the plurality of prospect-agent pairing models; and
selecting, using the hardware processor, a preferred model based on a desired outcome.

2. The method of claim 1, further comprising receiving an outcome data for a transaction after the transaction is completed.

3. The method of claim 1, further comprising optionally updating, using the hardware processor, the prospect-agent pairing model or models based on the outcome data.

4. The method of claim 1, wherein the historical transaction data includes prospect data, agent data, and task data.

5. The method of claim 1, where in the historical transaction data includes agent data and outcome data related to a plurality of transactions, wherein each transaction of the plurality of transaction is one of a sale of a product, a sale of a good, and a provision of a service.

6. The method of claim 1, wherein analyzing the historical transaction data includes analysis of a plurality of attributes, and wherein creating the plurality of prospect-agent pairing models optimizes the plurality of prospect-agent pairing models based on including the agent data as an attribute in the analysis.

7. A method for prospect-agent pairing using a system comprising a non-transitory memory storing an executable code and a hardware processor executing the executable, the method comprising:
receiving, using the hardware processor, a new inquiry requesting a prospect-agent pairing for a new transaction from a user;
generating, using the hardware processor, a prospect-agent pairing using the selected pairing model, wherein the prospect-agent pairing is based on a trained model optimized for pairing a prospect and an agent using the agent as an attribute in determining the ideal prospect-agent pairing; and
providing, using the hardware processor, the prospect-agent pairing results to the user.

8. The method of claim 7, wherein, prior to generating a prospect-agent pairing, the method comprises optionally enriching, using the hardware processor, the data with enrichment data.

9. The method of claim 7, further comprising optionally updating, using the hardware processor, the selected prospect-agent model used to select the prospect-agent pairing.

10. The method of claim 7, wherein the transaction is one of a sale of a product, a sale of a good, and a provision of a service.

11. The method of claim 7, the method further comprising updating, using the hardware processor, the training data and/or the generated model with transaction outcome information.

12. The method of claim 11, the method further comprising receiving, using the hardware processor, transaction outcome information.

13. The method of claim 7, wherein the prospect-agent pairing results include a probability of achieving a desired business outcome for a task.

14. A system for prospect-agent pairing comprising:
a non-transitory memory storing an executable code; and
a hardware processor executing the executable to:
receive a new inquiry requesting a prospect-agent pairing for a new transaction from a user;
generate a prospect-agent pairing using the selected pairing model, wherein the prospect-agent pairing is based on a trained model optimized for pairing a prospect and an agent using the agent as an attribute in determining the ideal prospect-agent pairing; and
provide the prospect-agent pairing results to the user.

15. The system of claim 14, wherein, prior to generating a prospect-agent pairing, the method comprises optionally enriching, using the hardware processor, the data with enrichment data.

16. The system of claim 14, further comprising optionally updating, using the hardware processor, the selected prospect-agent model used to select the prospect-agent pairing.

17. The system of claim 14, wherein the transaction is one of a sale of a product, a sale of a good, and a provision of a service.

18. The system of claim 14, wherein the hardware processor further updates the training data and/or the generated model with transaction outcome information.

19. The system of claim 18, wherein the hardware processor further receives transaction outcome information.

20. The system of claim 14, wherein the prospect-agent pairing results include a probability of achieving a desired business outcome for a task.
